(19) United States
(12) Patent Application Publication
(10) Pub. No.: US 2011/0234721 A1
(43) Pub. Date: Sep. 29, 2011

(54) ERASING APPARATUS, IMAGE FORMING APPARATUS, AND RECORDING MEDIUM IDENTIFYING METHOD

(75) Inventor: Sasuke ENDO, Kanagawa (JP)

(73) Assignees: Kabushiki Kaisha Toshiba, Tokyo (JP); Toshiba Tec Kabushiki Kaisha, Tokyo (JP)

(21) Appl. No.: 13/038,333

(22) Filed: Mar. 1, 2011

Related U.S. Application Data
(60) Provisional application No. 61/318,235, filed on Mar. 26, 2010.

(51) Int. Cl. B41J 2/01; B65H 7/02; B65H 7/20

(52) U.S. Cl. 347/101; 271/265.02; 271/255

(57) ABSTRACT

According to one embodiment, a recording medium identifying device includes: a sensor set downstream in a recording medium conveying direction of a heating device and configured to detect reflected light of a recording medium; and a control section configured to calculate a printing ratio of the recording medium and determine, if the printing ratio of the recording medium is equal to or larger than a threshold, that the recording medium is un-reusable. An erasing apparatus includes: the recording medium identifying device; a heating device configured to heat the recording medium to temperature equal to or higher than erasing temperature; a switching mechanism configured to switch a recording medium conveying path; and a disposal box in which unusable recording media are stored. If the control section determines that the recording medium is un-reusable, the control section controls the switching mechanism and stores the recording medium in the disposal box.

### CROSS-REFERENCE TO RELATED APPLICATIONS

This application is based upon and claims the benefit of priority from the prior the U.S. Patent Application No. 61/318,235, filed on Mar. 26, 2010, and the entire contents of which are incorporated herein by reference.

### FIELD

Embodiments described herein relate generally to an erasing apparatus, an image forming apparatus, and a recording medium identifying method.

### BACKGROUND

For saving of resources, in some cases, image formation is performed using an erasable developer. As the erasable developer, there are a toner, ink, and the like, colors of which are erased by heat. A recording medium on which an image is formed with the erasable developer is reused after being heated and subjected to erasing by the erasing apparatus.

However, if the recording medium is repeatedly reused many times or an image is formed at high density in a wide area of the recording medium, the recording medium is unsuitable for reuse. In other words, in some cases, the quality of an image formed on the recording medium is deteriorated. Further, since the thickness of the recording medium is increased by the thickness of the developer used to form images to be superimposed one on top of another, the lives of components such as a photoconductive drum and a transfer roller are reduced.

A recording medium identifying device in the past is a device that detects whether the developer is erased after erasing operation. Therefore, it is impossible to determine whether the recording medium on which an image is formed with the erasable developer and erased is suitable for reuse.

### BRIEF DESCRIPTION OF THE DRAWINGS

FIG. 1 is a side view of an erasing apparatus according to a first embodiment;

FIG. 2 is a block diagram of the configuration of the erasing apparatus according to the first embodiment;

FIG. 3 is a flowchart for explaining the operation of the erasing apparatus according to the first embodiment;

FIG. 4 is a side view of an erasing apparatus according to a second embodiment;

FIG. 5 is a block diagram of the configuration of the erasing apparatus according to the second embodiment;

FIG. 6 is a flowchart for explaining the operation of the erasing apparatus according to the second embodiment;

FIG. 7 is a side view of an erasing apparatus including a recording medium identifying device according to a third embodiment;

FIG. 8 is a diagram of an example of an image forming apparatus including an erasing mechanism;

FIG. 9 is a diagram of another example of the image forming apparatus;

FIG. 10 is a block diagram of the configurations of the image forming apparatus and the erasing apparatus according to the third embodiment; and

FIG. 11 is a flowchart for explaining the operations of the image forming apparatus and the erasing apparatus according to the third embodiment.

### DETAILED DESCRIPTION

Throughout this description, the embodiments and examples shown should be considered as exemplars, rather than limitations on the apparatus and methods of the present embodiments.

Exemplary embodiments of an erasing apparatus, an image formation apparatus and a recording medium identifying method according to the present invention are explained in detail below with reference to the accompanying drawings. In the following explanation, examples of an image forming apparatus include a copying machine, an MFP (Multifunction Peripheral), and a printer.

In general, according to one embodiment, an erasing apparatus includes: a recording medium conveying mechanism configured to convey a recording medium; a heating device configured to heat the recording medium to temperature equal to or higher than erasing temperature; a sensor provided downstream in a recording medium conveying direction of the heating device and configured to detect reflected light reflected by the recording medium; a switching mechanism provided downstream in the recording medium conveying direction of the sensor and configured to switch a recording medium conveying path; and a control section configured to detect a heated image on the recording medium on the basis of an output of the sensor, determine whether the recording medium is un-reusable, and, if the recording medium is un-reusable, control the switching mechanism and sort the recording medium.

### First Embodiment

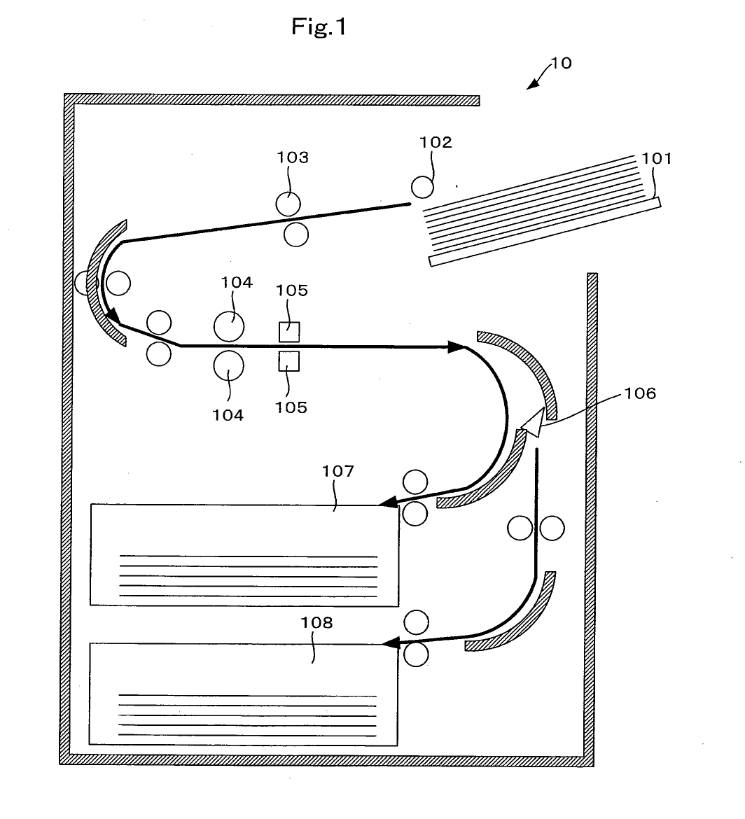

FIG. 1 is a side view of an erasing apparatus 10 including a recording medium identifying device according to a first embodiment. As shown in FIG. 1, the erasing apparatus 10 includes an inlet tray 101 on which recording media to be subjected to erasing are placed, a pickup roller 102 configured to pick up the recording media placed on the inlet tray 101 one by one, a conveying roller 103 included in a conveying device configured to convey the recording medium, a heating roller 104, as a heating device, included in an erasing mechanism configured to erase a developer on the recording medium, a sensor 105 set downstream in a recording medium conveying direction of the heating roller 104 and included in an identifying device configured to identify the recording medium, a switching mechanism 106 configured to switch a recording medium conveying path, a reuse box 107 in which reusable recording media are stored, and a disposal box 108 in which recording media determined as un-reusable are stored.

The erasing mechanism causes the heating roller 104 to generate heat and heats an erasable developer on the recording medium to temperature equal to or higher than erasing temperature to subject the recording medium to erasing.

The erasable developer includes a color assuming compound, a color developing agent, and an erasing agent. Examples of the color assuming compound include a leuco dye. Examples of the color developing agent include phenol. Examples of the erasing agent include a substance that, when heated, dissolves with the color assuming compound and does not have affinity with the color developing agent.

The erasable developer develops a color according to a mutual action of the color assuming compound and the color developing agent. Since the mutual action of the color assuming compound and the color developing agent is interrupted by heating at temperature equal to or higher than the erasing temperature, the erasable developer is erased.

The identifying device includes the sensor 105. The sensor 105 receives reflected light of light emitted from a light emitting element included in the identifying device and reflected by the recording medium. Examples of the sensor 105 include a line sensor. However, the sensor 105 is not limited to the line sensor and may be a CMOS sensor. The sensor 105 may be either a monochrome sensor or a color sensor.

The switching mechanism 106 switches a recording medium conveying path leading to the reuse box 107 and a recording medium conveying path leading to the disposal box 108.

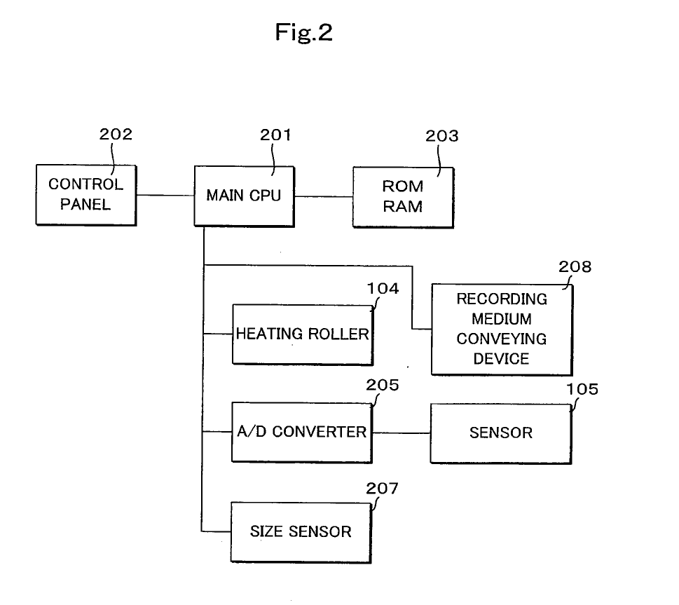

FIG. 2 is a block diagram of the configuration of the erasing apparatus 10 according to the first embodiment. As shown in FIG. 2, the erasing apparatus 10 includes a main CPU 201 serving as a control section configured to control the erasing apparatus 10, a control panel 202 serving as a display device, a ROM and RAM 203 serving as a storage device, the heating roller 104 of the erasing mechanism, the sensor 105, an A/D converter 205 configured to convert an analog output of the sensor 105 into a digital signal, and a size sensor 207 included in a recording medium conveying device 208 and configured to detect a size of a recording medium to be conveyed.

The main CPU 201 controls the recording medium conveying device 208. Specifically, the main CPU 201 controls a recording medium conveying operation of a recording medium conveying mechanism and controls a switching operation of the switching mechanism 106. The main CPU 201 controls a heating operation of the heating roller 104.

The size sensor 207 is set in a recording medium conveying path and outputs a signal according to a size of a recording medium that passes through the recording medium conveying path. The size sensor 207 may include, for example, an infrared sensor or an actuator.

The size sensor 207 is set in a region corresponding to the size of the recording medium in the recording medium conveying path. For example, a pair of the size sensors 207 for determining the size A4 are set at both ends of the width of an A4 recording medium.

The main CPU 201 receives output signals of the size sensor 207 and the A/D converter 205. The output signals are stored in the storage device. The main CPU 201 determines on the basis of a digital signal converted by the A/D converter 205 from an output of the sensor 105 whether the recording medium is reusable.

Specifically, first, the main CPU 201 determines a size of the recording medium on the basis of an output of the size sensor 207.

Subsequently, the main CPU 201 reads out the position of an unprintable area corresponding to the size of the recording medium from the storage device. The unprintable area means an area at a peripheral edge of the recording medium where image formation is impossible.

The main CPU 201 sets an output signal from the A/D converter 205 corresponding to the unprintable area as a reference value.

The main CPU 201 reads out threshold width from the storage device. The main CPU 201 subtracts the threshold width from the reference value to obtain a printing threshold. The threshold width is set to correspond to reflection intensity of reflection of light of a light emitting element by an erasable developer after erasing.

The main CPU 201 sequentially reads out output signals of the A/D converter 205 stored in the storage device. The main CPU 201 counts the number of values smaller than the printing threshold among read-out values. Specifically, the reflection intensity of a pixel in a section where an image is formed once and then erased is smaller than the printing threshold. Therefore, if the number of values smaller than the printing threshold is counted, the number of pixels subjected to image formation can be counted.

If a color sensor is used, the output signal of the A/D converter 205, the threshold width, and the printing threshold are stored by RGB signals. If at least one of an R value, a G value, and a B value of the RGB signal of the output signal is smaller than the printing threshold corresponding to the R value, the G value, and the B value, the main CPU 201 counts the R value, the G value, and the B value as values smaller than the printing threshold.

The main CPU 201 calculates a printing ratio. The following Formula (1) can be used to calculate the printing ratio:

(Printing ratio)=(the number of pixels having reflection intensity smaller than the printing threshold)/(a total number of pixels of the recording medium) (1)

The printing ratio represents in which extent of the surface of the recording medium an image is formed.

The main CPU 201 reads out a threshold of the printing ratio from the storage device. If the printing ratio exceeds the threshold of the printing ratio, the main CPU 201 determines that the recording medium is un-reusable.

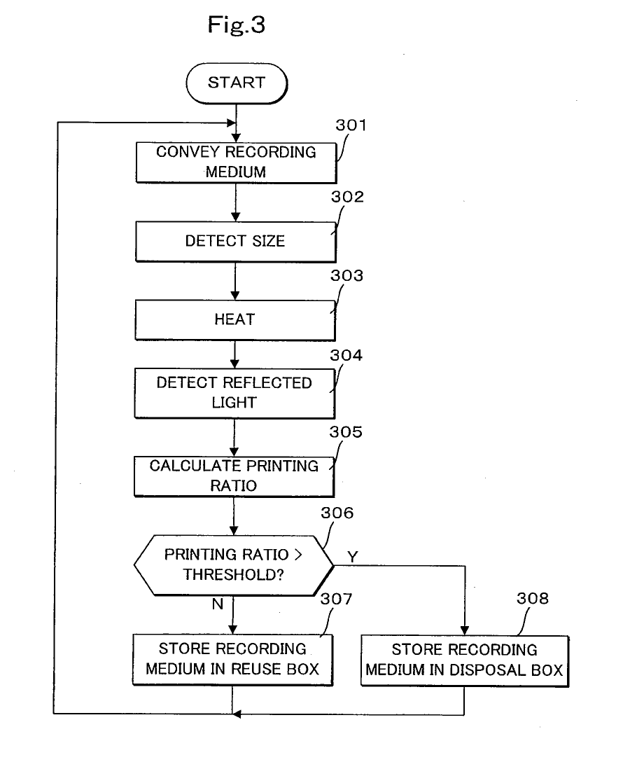

FIG. 3 is a flowchart for explaining the operation of the erasing apparatus 10 according to the first embodiment. As shown in FIG. 3, in Act 301, the erasing apparatus 10 conveys a recording medium.

In Act 302, the erasing apparatus 10 detects a size of the recording medium.

In Act 303, the erasing apparatus 10 causes the heating roller 104 of the erasing mechanism to generate heat and erases an erasable developer.

In Act 304, the erasing apparatus 10 detects, with the sensor 105, reflected light of light of the light emitting element reflected by the recording medium.

In Act 305, the erasing apparatus 10 calculates a printing ratio.

In Act 306, the erasing apparatus 10 determines whether the printing ratio exceeds the threshold. If the erasing apparatus 10 determines that the printing ratio is equal to or smaller than the threshold, the erasing apparatus 10 proceeds to Act 307. If the erasing apparatus determines that the printing ratio exceeds the threshold, the erasing apparatus 10 proceeds to Act 308.

In Act 307, the erasing apparatus 10 controls the switching device 106 to store the recording medium in the reuse box 107.

In Act 308, the erasing apparatus 10 controls the switching device 106 to store the recording medium in the disposal box 108.

As explained above, the recording medium identifying device according to the first embodiment includes the sensor 105 set downstream in the recording medium conveying direction of the heating roller 104 and configured to detect reflected light of a recording medium and the control section configured to calculate a printing ratio of the recording medium and to determine, if the printing ratio of the recording medium is equal to or larger than the threshold, that the recording medium is un-reusable.

The erasing apparatus 10 according to the first embodiment includes the recording medium identifying device, the heating roller 104 configured to heat a recording medium to temperature equal to or higher than the erasing temperature, the switching mechanism 106 configured to switch a conveying path for the recording medium, and the disposal box 108 in which un-reusable recording media are stored. If the control section determines that the recording medium is un-reusable, the control section controls the switching mechanism 106 to store the recording medium in the disposal box 108.

Therefore, there is an effect that the erasing apparatus 10 can accurately sort the un-reusable recording medium.

### Second Embodiment

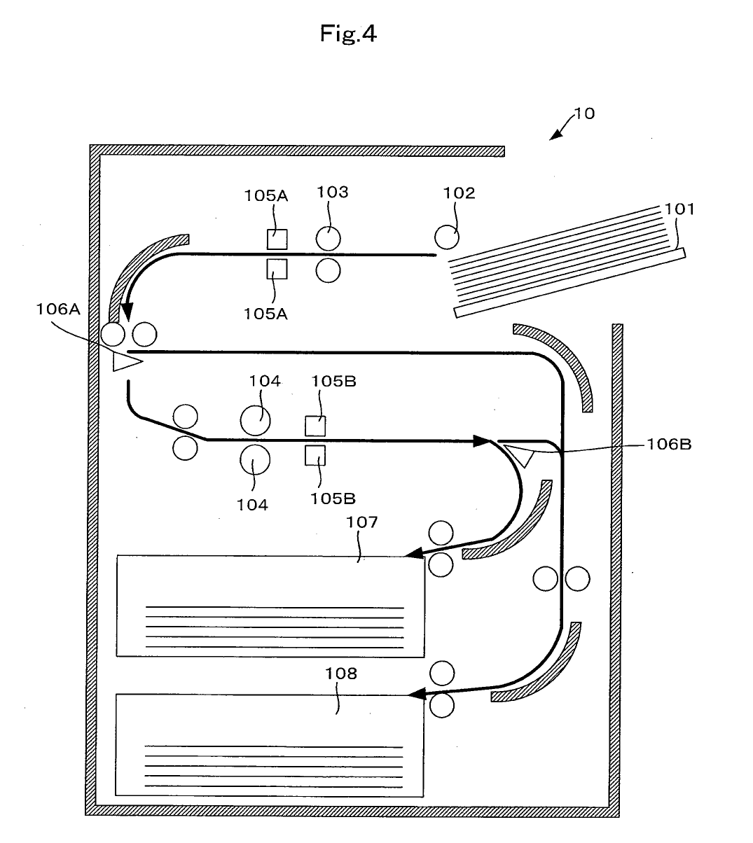

FIG. 4 is a side view of the erasing apparatus 10 including a recording medium identifying device according to a second embodiment. As shown in FIG. 4, the erasing apparatus 10 includes the inlet tray 101 on which recording media to be subjected to erasing are placed, the pickup roller 102 configured to pick up the recording media placed on the inlet tray 101 one by one, the conveying roller 103 included in a conveying device configured to convey the recording medium, the heating roller 104 included in an erasing mechanism configured to erase a developer on the recording medium, a first sensor 105A set upstream in a recording medium conveying direction of the heating roller 104 and included in an identifying device configured to identify the recording medium, a second sensor 105B set downstream in the recording medium conveying direction of the heating roller 104 and included in the identifying device configured to identify the recording medium, a first switching mechanism 106A set upstream in the recording medium conveying direction of the heating roller 104 and configured to switch a recording medium conveying path, a second switching mechanism 106B set downstream in the recording medium conveying direction of the heating roller 104 and configured to switch the recording medium conveying path, the reuse box 107 in which reusable recording media are stored, and the disposal box 108 in which recording media determined as un-reusable are stored.

The erasing mechanism causes the heating roller 104 to generate heat and heats an erasable developer on a recording medium to temperature equal to or higher than erasing temperature to subject the recording medium to erasing.

The identifying device includes the first sensor 105A and the second sensor 105B. The first sensor 105A and the second sensor 105B receive reflected light of light emitted from a light emitting element included in the identifying device and reflected by the recording medium. Examples of the first sensor 105A and the second sensor 105B include a line sensor. However, the first sensor 105A and the second sensor 105B are not limited to the line sensor and may be a CMOS sensor. The first sensor 105A and the second sensor 105B may be either a monochrome sensor or a color sensor.

The first switching mechanism 106A switches a recording medium conveying path leading to the heating roller 104 and a recording medium conveying path leading to the disposal box 108.

The second switching mechanism 106B switches a recording medium conveying path leading to the reuse box 107 and a recording medium conveying path leading to the disposal box 108.

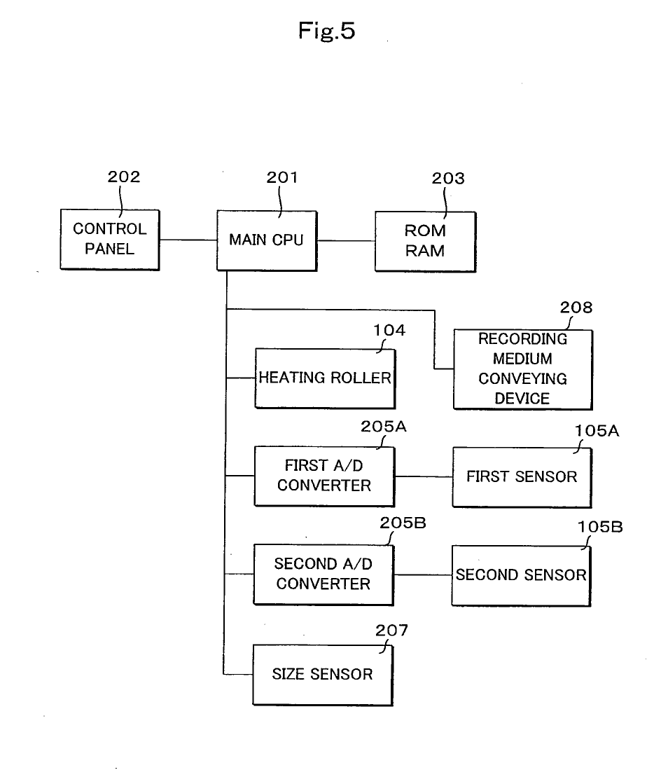

FIG. 5 is a block diagram of the configuration of the erasing apparatus 10 according to the second embodiment. As shown in FIG. 5, the erasing apparatus 10 includes the main CPU 201 serving as a control section configured to control the erasing apparatus 10, the control panel 202 serving as a display device, the ROM and RAM 203 serving as a storage device, the heating roller 104 of the erasing mechanism, the first sensor 105A and the second sensor 105B, a first A/D converter 205A configured to convert an analog output of the first sensor 105A into a digital signal, a second A/D converter 205B configured to convert an analog output of the second sensor 105B into a digital signal, and the size sensor 207 included in the recording medium conveying device 208 and configured to detect a size of a recording medium to be conveyed.

The main CPU 201 controls the recording medium conveying device 208. Specifically, the main CPU 201 controls a recording medium conveying operation of a recording medium conveying mechanism and controls switching operations of the first switching mechanism 106A and the second switching mechanism 106B. The main CPU 201 controls a heating operation of the heating roller 104.

The size sensor 207 is set in a recording medium conveying path and outputs a signal according to a size of a recording medium that passes through the recording medium conveying path. The size sensor 207 may include, for example, an infrared sensor or an actuator.

The size sensor 207 is set in a region corresponding to the size of the recording medium in the recording medium conveying path. For example, a pair of the size sensors 207 for determining the size A4 are set at both ends of the width of an A4 recording medium.

The main CPU 201 receives output signals of the size sensor 207 and the first A/D converter 205A and the second A/D converter 205B. The output signals are stored in the storage device. The main CPU 201 determines on the basis of digital signals converted by the first A/D converter 205A and the second A/D converter 205B from outputs of the first sensor 105A and the second sensor 105B whether the recording medium is reusable.

Specifically, first, the main CPU 201 determines a size of the recording medium on the basis of an output of the size sensor 207.

Subsequently, the main CPU 201 reads out the position of an unprintable area corresponding to the size of the recording medium from the storage device. The unprintable area means an area at a peripheral edge of the recording medium where image formation is impossible.

The main CPU 201 sets an output signal from the first A/D converter 205A corresponding to the unprintable area as a reference value.

The main CPU 201 reads out threshold width from the storage device. The main CPU 201 subtracts the threshold width from the reference value to obtain a printing threshold. The threshold width is set to correspond to reflection intensity of reflection of light of a light emitting element by an erasable developer after erasing.

The main CPU 201 sequentially reads out output signals of the first A/D converter 205A stored in the storage device. The main CPU 201 counts the number of values smaller than the printing threshold among read-out values. In other words, the reflection intensity of a pixel in a section where an image is formed once and then erased is smaller than the printing threshold. Therefore, if the number of values smaller than the printing threshold is counted, the number of pixels subjected to image formation can be counted.

If a color sensor is used, the output signal of the first A/D converter 205A, the threshold width, and the printing threshold are stored by RGB signals. If at least one of an R value, a G value, and a B value of the RGB signal of the output signal is smaller than the printing threshold corresponding to the R value, the G value, and the B value, the main CPU 201 counts the R value, the G value, and the B value as values smaller than the printing threshold.

The main CPU 201 calculates a printing ratio. The Formula (1) can be used to calculate the printing ratio.

The printing ratio represents in which extent of the surface of the recording medium an image is formed.

The main CPU 201 reads out a threshold of the printing ratio from the storage device. If the printing ratio exceeds the threshold of the printing ratio, the main CPU 201 determines that the recording medium is un-reusable.

The main CPU 201 controls the first switching mechanism 106A to convey a recording medium determined as reusable to the heating roller 104 and heats the recording medium with the heating roller 104 to subject the recording medium to erasing.

The main CPU 201 determines, using the second sensor 105B and the second A/D converter 205B, whether the recording medium after the erasing is reusable.

A method and an operation for determining reusability using the second sensor 105B and the second A/D converter 205B are the same as the method and the operation for determining reusability using the first sensor 105A and the first A/D converter 205A.

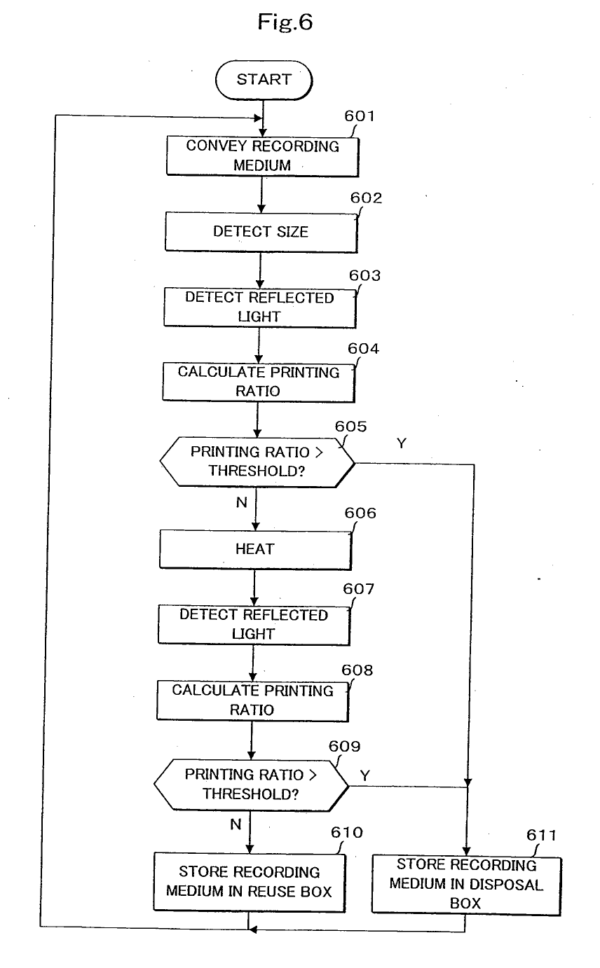

FIG. 6 is a flowchart for explaining the operation of the erasing apparatus 10 according to the second embodiment. As shown in FIG. 6, in Act 601, the erasing apparatus 10 conveys a recording medium.

In Act 602, the erasing apparatus 10 detects a size of the recording medium.

In Act 603, the erasing apparatus 10 detects, with the first sensor 105A, reflected light of light of the light emitting element reflected by the recording medium.

In Act 604, the erasing apparatus 10 calculates a printing ratio.

In Act 605, the erasing apparatus 10 determines whether the printing ratio exceeds the threshold. If the erasing apparatus 10 determines that the printing ratio is equal to or smaller than the threshold, the erasing apparatus 10 proceeds to Act 606. If the erasing apparatus determines that the printing ratio exceeds the threshold, the erasing apparatus 10 proceeds to Act 611.

In Act 606, the erasing apparatus 10 causes the heating roller 104 of the erasing mechanism to generate heat and erases an erasable developer.

In Act 607, the erasing apparatus 10 detects, with the second sensor 105B, reflected light of light of the light emitting element reflected by the recording medium.

In Act 608, the erasing apparatus 10 calculates a printing ratio.

In Act 609, the erasing apparatus 10 determines whether the printing ratio is smaller than the threshold. If the erasing apparatus 10 determines that the printing ratio is smaller than the threshold, the erasing apparatus 10 proceeds to Act 610. If the erasing apparatus 10 determines that the printing ratio is equal to or larger than the threshold, the erasing apparatus 10 proceeds to Act 611.

In Act 610, the erasing apparatus 10 controls the switching device 106 to store the recording medium in the reuse box 107.

In Act 611, the erasing apparatus 10 controls the switching device 106 to store the recording medium in the disposal box 108.

As explained above, the recording medium identifying device according to the second embodiment includes the first sensor 105A set upstream in the recording medium conveying direction of the heating roller 104 and configured to detect reflected light of a recording medium, the second sensor 105B set downstream in the recording medium conveying direction of the heating roller 104 and configured to detect reflected light of the recording medium, and the control section configured to calculate a printing ratio of the recording medium and determine, if the printing ratio of the recording medium is equal to or larger than the threshold, that the recording medium is un-reusable.

The erasing apparatus 10 according to the second embodiment includes the recording medium identifying device, the heating roller 104 configured to heat a recording medium to temperature equal to or higher than the erasing temperature, the first switching mechanism 106A and the second switching mechanism 106B configured to switch a conveying path for the recording medium, and the disposal box 108 in which un-reusable recording media are stored. If the control section determines that the recording medium is un-reusable, the control section controls the first switching mechanism 106A and the second switching mechanism 106B to store the recording medium in the disposal box 108.

Therefore, there is an effect that the erasing apparatus 10 can more accurately and quickly sort the un-reusable recording medium.

### Third Embodiment

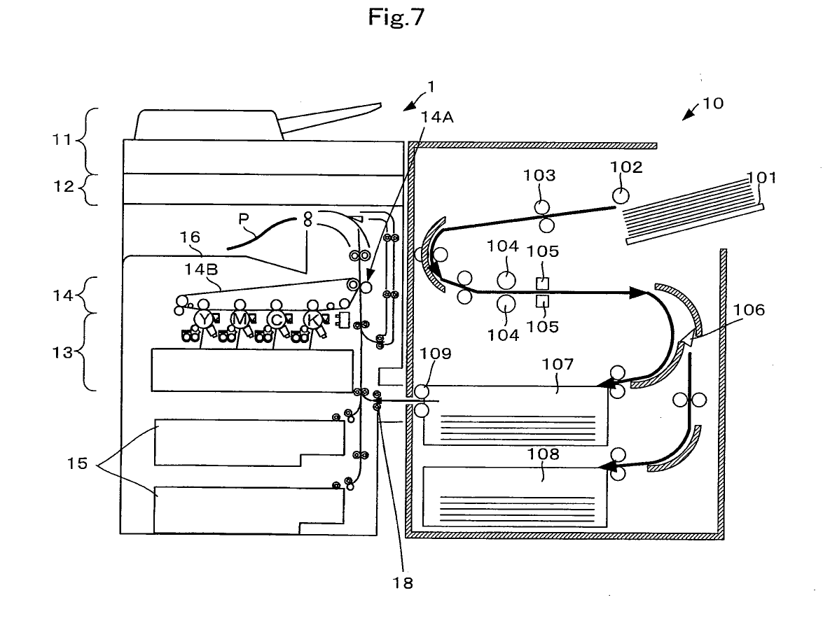

FIG. 7 is a side view of the erasing apparatus 10 including the recording medium identifying device according to a third embodiment. As shown in FIG. 7, the erasing apparatus 10 includes the inlet tray 101 on which recording media to be subjected to erasing are placed, the pickup roller 102 configured to pick up the recording media placed on the inlet tray 101 one by one, the conveying roller 103 included in a conveying device configured to convey the recording medium, the heating roller 104 included in an erasing mechanism configured to erase a developer on the recording medium, the sensor 105 set downstream in a recording medium conveying direction of the heating roller 104 and included in an identifying device configured to identify the recording medium, the switching mechanism 106 configured to switch a recording medium conveying path, the reuse box 107 in which reusable recording media are stored, the disposal box 108 in which recording media determined as un-reusable are stored, and a discharge roller 109 set in the reuse box 107.

The erasing mechanism causes the heating roller 104 to generate heat and heats an erasable developer on the recording medium to temperature equal to or higher than erasing temperature to subject the recording medium to erasing.

The identifying device includes the sensor 105. The sensor 105 receives reflected light of light emitted from a light emitting element included in the identifying device and reflected by the recording medium. Examples of the sensor 105 include a line sensor. However, the sensor 105 is not limited to the line sensor and may be a CMOS sensor. The sensor 105 may be either a monochrome sensor or a color sensor.

The switching mechanism 106 switches a recording medium conveying path leading to the reuse box 107 and a recording medium conveying path leading to the disposal box 108.

The erasing apparatus 10 is set adjacent to an image forming apparatus 1. The image forming apparatus 1 includes an auto document feeder 11, an image reading section 12, an image forming section 13, and a transfer section 14.

The auto document feeder 11 is openably and closably set in an upper part of a frame of the image forming apparatus 1. The auto document feeder 11 picks up original documents one by one and feeds the original document to the image reading section 12.

The image reading section 12 includes a carriage including an exposure lamp configured to expose the original document to light and a first reflection mirror, plural second reflection mirrors locked to a main body frame of the image forming apparatus 1, a lens block, and a CCD (Charge Coupled Device) of an image reading sensor.

The carriage is at a standstill in a document reading section or reciprocatingly moves under a document table and reflects the light of the exposure lamp, which is reflected by the original document, to the first reflection mirror. The plural second reflection mirrors reflect the reflected light of the first reflection mirror to the lens block. The lens block outputs the reflected light to the CCD. The CCD converts the incident light into an electric signal and outputs the electric signal to the image forming section 13 as an image signal.

The image forming section 13 includes a photoconductive drum serving as an electrostatic latent image bearing member, a charging device, a laser irradiating unit, a developing device, and a developer supplying device.

The charging device applies a voltage to the photoconductive drum and charges the photoconductive drum. The laser irradiating unit irradiates a laser beam on the photoconductive drum on the basis of the image signal and forms an electrostatic latent image on the photoconductive drum serving as the electrostatic latent image bearing member.

The developer supplying device supplies a fresh developer to the developing device. The developing device supplies the developer to the photoconductive drum and forms a developer image from the electrostatic latent image.

The recording medium conveying mechanism includes, most upstream on a paper feeding unit 15 side, a pickup mechanism configured to pickup recording media one by one.

The recording medium conveying mechanism includes, upstream of the transfer section 14 in a conveying path, a receiving roller 18 configured to receive a reusable recording medium from the discharge roller 109 of the erasing apparatus 10.

The pickup mechanism picks up recording media from the paper feeding unit 15 one by one and passes the recording medium to the recording medium conveying mechanism. The receiving roller 18 passes the received recording medium to the recording medium conveying mechanism. The recording medium conveying mechanism conveys the recording medium to the transfer section 14 via an aligning roller.

A transfer roller 14A applies a voltage or applies pressure and transfers the developer image, which is transferred from the photoconductive drum to a transfer belt 14B, onto the recording medium conveyed to the transfer roller 14A. A fixing roller heats and presses the developer image and fixes the developer image on the recording medium.

The image forming apparatus 1 discharges the recording medium, which passes the fixing roller, from a paper discharge port. The recording medium P discharged from the paper discharge port is stacked on a paper discharge tray 16.

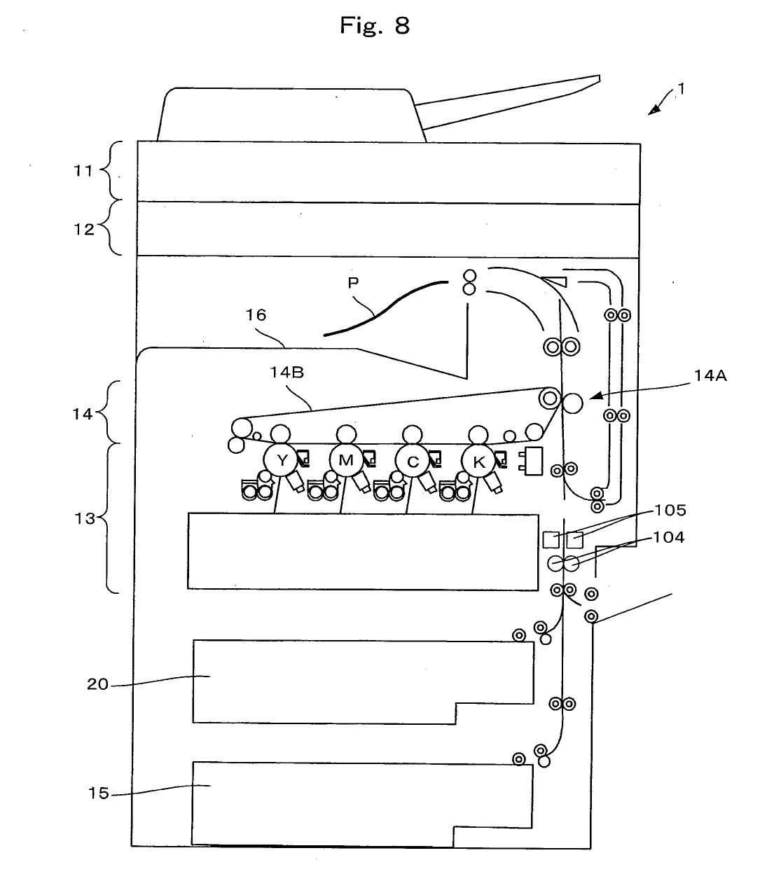

FIG. 8 is a diagram of an example of the image forming apparatus 1 including the erasing mechanism. As shown in FIG. 8, the image forming apparatus 1 may include the erasing mechanism.

The image forming apparatus 1 including the erasing mechanism includes the sensor 105 upstream of the transfer roller 14A and includes the heating roller 104 upstream of the sensor 105. Functions and operations of the sensor 105 and the heating roller 104 of the erasing mechanism are the same as the functions and the operations of the sensor 105 and the heating roller 104 of the erasing apparatus 10.

The image forming apparatus 1 may include a waste paper box 20 in which un-reusable recording media are stored.

The recording medium conveying mechanism of the image forming apparatus 1 reversely feeds a recording medium determined as un-reusable and stores the recording medium in the waste paper box 20.

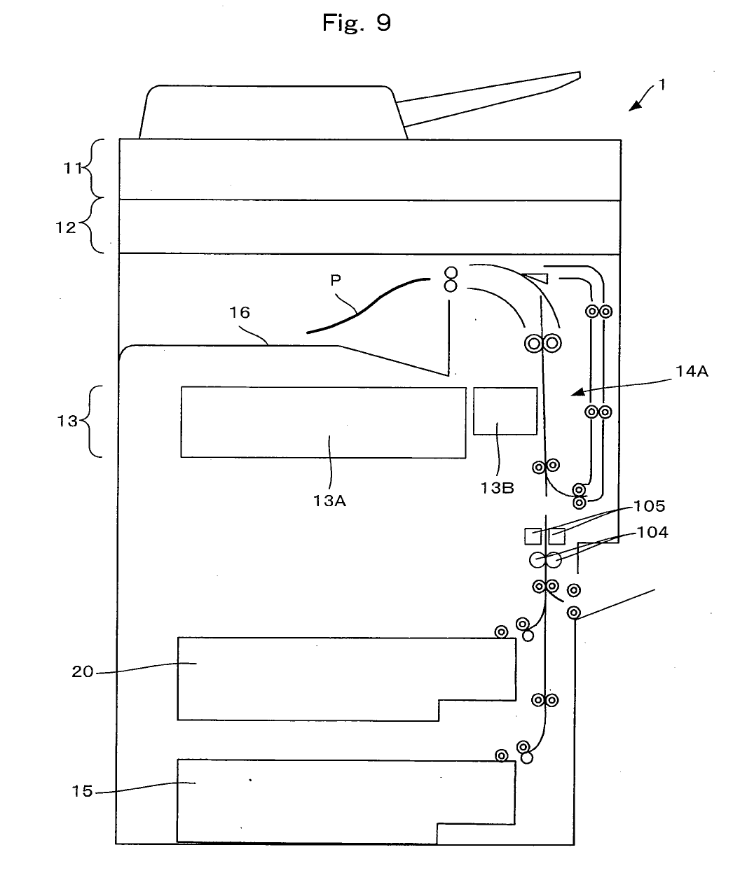

FIG. 9 is a diagram of another example of the image forming apparatus 1. As shown in FIG. 9, in the image forming section 13 of the image forming apparatus 1, an inkjet image forming apparatus 13B or a dot impact image forming apparatus 13B can be used instead of an electronic image forming apparatus explained above.

In the inkjet image forming apparatus 13B, piezoelectric elements having polarities different from one another are arrayed in a comb teeth shape. The inkjet image forming apparatus 13B leads erasable ink into spaces among the comb teeth-shaped piezoelectric elements, applies a voltage to the piezoelectric elements to deform the piezoelectric elements, and ejects the ink from nozzle holes to thereby form an image.

The dot impact image forming apparatus 13B brings, with plural dot pins arranged in a matrix shape, an ink ribbon infiltrated with erasable ink into contact with a recording medium and forms an image.

If the inkjet image forming apparatus 13B or the dot impact image forming apparatus 13B is used, an image processing section 13A converts image data into a driving signal for driving the inkjet image forming apparatus 13B or the dot impact image forming apparatus 13B.

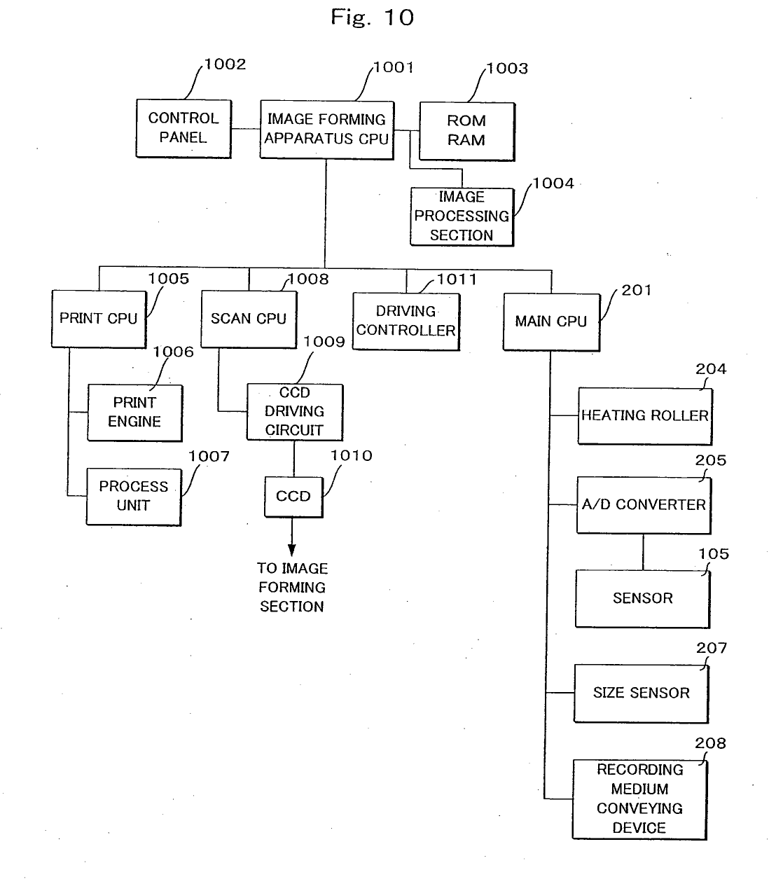

FIG. 10 is a block diagram of the configurations of the image processing apparatus 1 and the erasing apparatus 10 according to the third embodiment. As shown in FIG. 10, the image forming apparatus 1 includes an image forming apparatus CPU 1001 configured to collectively control the image forming apparatus 1, a control panel 1002 serving as a display device, a ROM and RAM 1003 serving as a storage device, an image processing section 1004 configured to perform processing of image data, and a print CPU 1005, a scan CPU 1008, a driving controller 1011, and a main CPU 201 connected to the image forming apparatus CPU 1001.

The print CPU 1005 controls a print engine 1006 and a process unit 1007.

The scan CPU 1008 controls a CCD driving circuit 1009 configured to drive a CCD 1010. The CCD 1010 outputs an output signal to the image forming apparatus 1.

The driving controller 1011 controls the recording medium conveying mechanism of the image forming apparatus 1.

The erasing apparatus 10 includes the main CPU 201 serving as a control section configured to control the erasing apparatus 10, the heating roller 104 of the erasing mechanism, the sensor 105, the A/D converter 205 configured to convert an analog output of the sensor 105 into a digital signal, and the size sensor 207 included in the recording medium conveying device and configured to detect a size of a recording medium to be conveyed.

The main CPU 201 controls the recording medium conveying device 208. Specifically, the main CPU 201 controls a recording medium conveying operation of the recording medium conveying mechanism and controls a switching operation of the switching mechanism 106. The main CPU 201 controls a heating operation of the heating roller 104.

The size sensor 207 is set in the recording medium conveying path and outputs a signal according to a size of a recording medium that passes through the recording medium conveying path. The size sensor 207 may include, for example, an infrared sensor or an actuator.

The size sensor 207 is set in a region corresponding to the size of the recording medium in the recording medium conveying path. For example, the size sensor 207 for determining the size A4 is set at both ends of the width of an A4 recording medium.

The main CPU 201 receives output signals of the size sensor 207 and the A/D converter 205. The output signals are stored in the storage device. The main CPU 201 determines on the basis of a digital signal converted by the A/D converter 205 from an output of the sensor 105 whether the recording medium is reusable.

Specifically, first, the main CPU 201 determines a size of the recording medium on the basis of an output of the size sensor.

Subsequently, the main CPU 201 reads out the position of an unprintable area corresponding to the size of the recording medium from the storage device. The unprintable area means an area at a peripheral edge of the recording medium where image formation is impossible.

The main CPU 201 sets an output signal from the A/D converter 205 corresponding to the unprintable area as a reference value.

The main CPU 201 reads out threshold width from the storage device. The main CPU 201 subtracts the threshold width from the reference value to obtain a printing threshold. The threshold width is set to correspond to reflection intensity of reflection of light of a light emitting element by an erasable developer after erasing.

The main CPU 201 sequentially reads out output signals of the A/D converter 205 stored in the storage device. The main CPU 201 counts the number of values smaller than the printing threshold among read-out values. The reflection intensity of a pixel in a section where an image is formed once and then erased is smaller than the printing threshold. Therefore, if the number of values smaller than the printing threshold is counted, the number of pixels subjected to image formation can be counted.

If a color sensor is used, the output signal of the A/D converter 205, the threshold width, and the printing threshold are stored by RGB signals. If at least one of an R value, a G value, and a B value of the RGB signal of the output signal is smaller than the printing threshold corresponding to the R value, the G value, and the B value, the main CPU 201 counts the R value, the G value, and the B value as values smaller than the printing threshold.

The main CPU 201 calculates a printing ratio. The Formula (1) can be used to calculate the printing ratio.

The printing ratio represents in which extent of the surface of the recording medium an image is formed.

The main CPU 201 reads out a threshold of the printing ratio from the storage device. If the printing ratio exceeds the threshold of the printing ratio, the main CPU 201 determines that the recording medium is un-reusable.

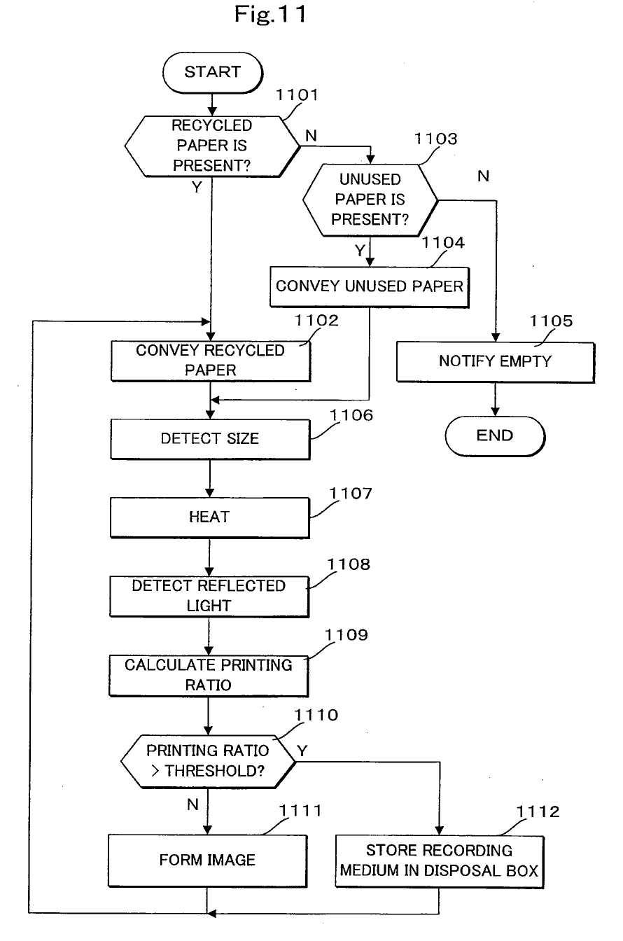

FIG. 11 is a flowchart for explaining the operations of the image forming apparatus 1 and the erasing apparatus 10 according to the third embodiment. As shown in FIG. 11, in Act 1101, the image forming apparatus 1 determines whether recycled paper, which is a reusable recording medium, is present. If recycled paper is present, the image forming apparatus 1 proceeds to Act 1102. If no recycled paper is present, the image forming apparatus 1 proceeds to Act 1103.

In Act 1103, the image forming apparatus 1 determines whether unused paper is present. If unused paper is present, the image forming apparatus 1 proceeds to Act 1104. If no unused paper is present, the image forming apparatus 1 proceeds to Act 1105.

In Act 1102, the image forming apparatus 1 conveys the recycled paper. In Act 1104, the image forming apparatus 1 conveys the unused paper. In Act 1105, the image forming apparatus 1 displays, on the control panel 1002, empty notification indicating that no sheet is present.

In Act 1106, the image forming apparatus 1 detects a size of the recording medium.

In Act 1107, the image forming apparatus 1 causes the heating roller 104 of the erasing mechanism of the image forming apparatus 1 to generate heat and erases an erasable developer.

In Act 1108, the image forming apparatus 1 detects, with the sensor 105, reflected light of light of the light emitting element reflected by the recording medium.

In Act 1109, the image forming apparatus 1 calculates a printing ratio.

In Act 1110, the image forming apparatus 1 determines whether the printing ratio exceeds a threshold. If the image forming apparatus 1 determines that the printing ratio is equal to or smaller than the threshold, the image forming apparatus 1 proceeds to Act 1111. If the image forming apparatus 1 determines that the printing ratio exceeds the threshold, the image forming apparatus 1 proceeds to Act 1112.

In Act 1111, the image forming apparatus 1 forms an image on the recording medium.

In Act 1112, the image forming apparatus 1 operates the recording medium conveying mechanism in reverse and stores the recording medium in the waste paper box 20 or the erasing apparatus 10 controls the switching device 106 to store the recording medium in the disposal box 108.

As explained above, the recording medium identifying device according to the third embodiment includes the sensor 105 set downstream in the recording medium conveying direction of the heating roller 104 and configured to detect reflected light of a recording medium and the control section configured to calculate a printing ratio of the recording medium and determines, if the printing ratio of the recording medium is equal to or larger than the threshold, that the recording medium is un-reusable.

The erasing apparatus 10 according to the third embodiment includes the recording medium identifying device, the heating roller 104 configured to heat a recording medium to temperature equal to or higher than the erasing temperature, the switching mechanism 106 configured to switch a conveying path for the recording medium, and the disposal box 108 in which un-reusable recording media are stored. If the control section determines that the recording medium is un-reusable, the control section controls the switching mechanism 106 to store the recording medium in the disposal box 108.

The image forming apparatus 1 according to the third embodiment stores un-reusable recording media in the waste paper box 20.

Therefore, the image forming apparatus 1 has an effect that it is possible to form images on only reusable recording media without manually sorting un-reusable recording media.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. An erasing apparatus comprising:
a recording medium conveying mechanism configured to convey a recording medium;
a heating device configured to heat the recording medium to temperature equal to or higher than erasing temperature;
a sensor provided downstream in a recording medium conveying direction of the heating device and configured to detect reflected light reflected by the recording medium;
a switching mechanism provided downstream in the recording medium conveying direction of the sensor and configured to switch a recording medium conveying path; and
a control section configured to detect a heated image on the recording medium on the basis of an output of the sensor, determine on the basis of the heated image whether the recording medium is un-reusable, and, if the recording medium is un-reusable, control the switching mechanism and sort the recording medium.

2. The apparatus according to claim 1, wherein, if a ratio of the heated image to the entire recording medium is equal to or larger than a threshold, the control section determines that the recording medium is un-reusable.

3. The apparatus according to claim 1, wherein the control section sets, with reference to reflected light in a section of the recording medium where image formation is impossible, a threshold for determining the heated image.

4. The apparatus according to claim 1, wherein the sensor is a color sensor.

5. The apparatus according to claim 1, further comprising:
an upstream sensor provided upstream in the recording medium conveying direction of the heating device and configured to detect reflected light reflected by the recording medium; and
an upstream switching mechanism provided upstream in the recording medium conveying direction of the heating device and configured to switch a recording medium conveying path.

6. The apparatus according to claim 5, wherein, if the control section determines on the basis of an output of the upstream sensor that a ratio of the heated image to the entire recording medium is equal to or larger than a threshold, the control section controls the upstream switching mechanism and sorts the recording medium.

7. The apparatus according to claim 1, further comprising a discharge roller configured to pass a reusable recording medium to an image forming apparatus set adjacent to the apparatus.

8. An image forming apparatus comprising:
a recording medium conveying mechanism configured to convey a recording medium;
an image forming section configured to form an image on the recording medium; and
a receiving roller configured to receive a recording medium sorted as reusable by an erasing apparatus including:
a recording medium conveying mechanism configured to convey a recording medium;
a heating device configured to heat the recording medium to temperature equal to or higher than erasing temperature;
a sensor provided downstream in a recording medium conveying direction of the heating device and configured to detect reflected light reflected by the recording medium;
a switching mechanism provided downstream in the recording medium conveying direction of the sensor and configured to switch a recording medium conveying path; and
a control section configured to detect a heated image on the recording medium on the basis of an output of the sensor, determine on the basis of the heated image whether the recording medium is un-reusable, and, if the recording medium is un-reusable, control the switching mechanism and sort the recording medium.

9. The apparatus according to claim 8, wherein, if a ratio of the heated image to the entire recording medium is equal to or larger than a threshold, the control section determines that the recording medium is un-reusable.

10. The apparatus according to claim 8, wherein the control section sets, with reference to reflected light in a section of the recording medium where image formation is impossible, a threshold for determining the heated image.

11. The apparatus according to claim 8, wherein the sensor is a color sensor.

12. The apparatus according to claim 8, further comprising:
an upstream sensor provided upstream in the recording medium conveying direction of the heating device and configured to detect reflected light reflected by the recording medium; and
an upstream switching mechanism provided upstream in the recording medium conveying direction of the heating device and configured to switch a recording medium conveying path.

13. The apparatus according to claim 12, wherein, if the control section determines on the basis of an output of the upstream sensor that a ratio of the heated image to the entire recording medium is equal to or larger than a threshold, the control section controls the upstream switching mechanism and sorts the recording medium.

14. The apparatus according to claim 8, wherein the image forming section is an electronic image forming apparatus.

15. The apparatus according to claim 8, wherein the image forming section is an inkjet image forming apparatus.

16. A recording medium identifying method for an erasing apparatus including a control section, the method comprising:
detecting a heated image on a recording medium on the basis of an output of a sensor;
determining on the basis of the heated image whether the recording medium is un-erasable; and
controlling, if the recording medium is un-reusable, a switching mechanism and sorting the recording medium.

17. The method according to claim 16, wherein further comprising determining, if a ratio of the heated image to the entire recording medium is equal to or larger than a threshold, that the recording medium is un-reusable.

18. The method according to claim 16, further comprising setting, with reference to reflected light of a section of the recording medium where image formation is impossible, a threshold for determining the heated image.

19. The method according to claim 16, further comprising determining the heated image on the basis of a signal corresponding to a color output by the sensor.

20. The method according to claim 16, further comprising:
determining on the basis of an output of an upstream sensor provided upstream in a recording medium conveying direction of a heating device and configured to detect reflected light reflected by the recording medium that the recording medium is un-reusable; and
controlling, if it is determined that the recording medium is un-reusable, an upstream switching mechanism provided upstream in the recording medium conveying direction of the heating device and configured to switch a recording medium conveying path and sorting the recording medium.
